(19) United States
(12) Patent Application Publication
(10) Pub. No.: US 2013/0009499 A1
(43) Pub. Date: Jan. 10, 2013

(54) BEARING ASSEMBLY AND MOTOR INCLUDING THE SAME

(75) Inventors: Dong Hyun Lee, Seoul (KR); Sang Won Kim, Gunpo (KR)

(73) Assignee: SAMSUNG ELECTRO-MECHANICS CO., LTD., Suwon (KR)

(21) Appl. No.: 13/437,535

(22) Filed: Apr. 2, 2012

(30) Foreign Application Priority Data
Jul. 8, 2011 (KR) 10-2011-0067782

(51) Int. Cl. F16C 33/74; H02K 7/08

(52) U.S. Cl. 310/90; 384/130

(57) ABSTRACT

There is provided a bearing assembly including: a sleeve supporting a shaft; a stopper coupled to the shaft to thereby prevent excessive floating of the shaft; a base cover maintaining a clearance with the stopper to thereby provide a space in which oil is filled and coupled to the sleeve; and a flow prevention part protruding from at least one of the stopper and the base cover to thereby prevent a flowing of the oil.

### CROSS-REFERENCE TO RELATED APPLICATIONS

This application claims the priority of Korean Patent Application No. 10-2011-0067782 filed on Jul. 8, 2011, in the Korean Intellectual Property Office, the disclosure of which is incorporated herein by reference.

### BACKGROUND OF THE INVENTION

1. Field of the Invention

The present invention relates to a bearing assembly and a motor including the same, and more particularly, to a motor capable of being used in a hard disk drive (HDD) rotating a recording disk.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized spindle motor is used.

In the small-sized spindle motor, a fluid dynamic bearing has been used. The fluid dynamic bearing indicates a bearing in which a shaft, a rotating member, and a sleeve, fixed member, include oil interposed therebetween, such that the shaft is supported by fluid pressure generated in the oil.

In addition, the spindle motor includes a plane shaped stopper under the shaft to thereby prevent excessive floating of the rotating member, wherein the stopper provides damping force when vibrations in an axial direction, disturbances, external impacts, or the like, are generated.

However, in the case of the stopper according to the related art, when vibrations in an axial direction, disturbances, external impacts, or the like, are generated, oil flows freely, such that contact between the stopper and a corresponding component may be generated.

That is, the stopper according to the related art has a limitation in providing sufficient damping force for suppressing displacement in a rotating member in an axial direction due to an external impact, or the like.

Therefore, research into a technology for significantly increasing performance and a lifespan of a spindle motor by significantly decreasing displacement of a rotating member in an axial direction through the suppression of the flow of oil even in the case that disturbances, external impacts, or the like are applied to the spindle motor has been urgently demanded.

### SUMMARY OF THE INVENTION

An aspect of the present invention provides a bearing assembly capable of significantly decreasing displacement in a rotating member in an axial direction by improving damping force for external impacts, or the like, and a motor including the same.

According to an aspect of the present invention, there is provided a bearing assembly including: a sleeve supporting a shaft; a stopper coupled to the shaft to thereby prevent excessive floating of the shaft; a base cover maintaining a clearance with the stopper to thereby provide a space in which oil is filled and coupled to the sleeve; and a flow prevention part protruding from at least one of the stopper and the base cover to thereby prevent a flowing of the oil.

The flow prevention part may be continuously or discontinuously formed along a bottom surface of the stopper in a circumferential direction.

The flow prevention part may have the same outer diameter as that of the stopper.

An inner space formed by the flow prevention part may have a constant or differing depth.

The flow prevention part may be formed symmetrically, based on the center of rotation of the stopper.

The flow prevention part may have an inner diameter 0.6 times smaller than an outer diameter of the stopper.

The stopper and the shaft may be formed integrally with each other.

According to another aspect of the present invention, there is provided a motor including: the bearing assembly as described above; a hub rotating together with the shaft and including a magnet coupled thereto; and a base coupled to the sleeve and including a core having a coil wound therearound, the coil generating rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor including a bearing assembly according to an embodiment of the present invention;

FIG. 2 is an exploded perspective view schematically showing a bearing assembly according to an embodiment of the present invention;

FIG. 3 is an enlarged cross-sectional view schematically showing a modified example of part A of FIG. 1;

FIG. 4 is a bottom perspective view schematically showing a shaft and a stopper provided in a modified example of part A of FIG. 1;

FIG. 5 is an enlarged cross-sectional view schematically showing another modified example of part A of FIG. 1;

FIG. 6 is a bottom perspective view schematically showing a shaft and a stopper provided in another modified example of part A of FIG. 1;

FIG. 7 is an exploded cross-sectional view schematically showing a situation in which an external impact is applied to a stopper included in a bearing assembly according to an embodiment of the present invention; and

FIG. 8 is a graph showing a relationship between an inner diameter of a flow prevention part included in a bearing assembly according to an embodiment of the present invention and damping force.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

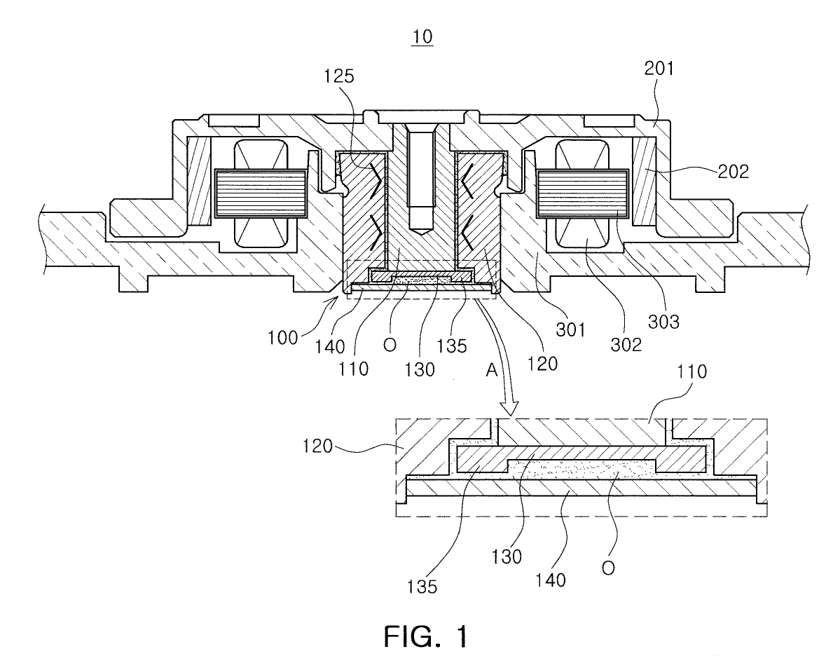

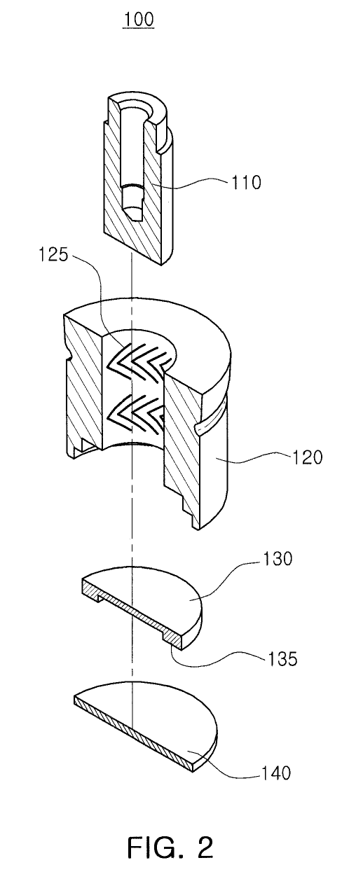

FIG. 1 is a cross-sectional view schematically showing a motor including a bearing assembly according to an embodiment of the present invention; and FIG. 2 is an exploded perspective view schematically showing a bearing assembly according to an embodiment of the present invention.

Referring to FIGS. 1 and 2, a motor 10 including a bearing assembly 100 according to an embodiment of the present invention may include a bearing assembly 100 including a fluid dynamic bearing, a hub 201 having a magnet 202 coupled thereto, and a base 301 having a core 303 coupled thereto, the core 303 having a coil 302 wound therearound.

Terms with respect to directions will first be defined. As viewed in FIG. 1, an axial direction refers to a vertical direction based on the shaft 110, and an outer diameter or inner diameter direction refers to a direction towards an outer edge of the hub 201 based on the shaft 110 or a direction towards the center of the shaft 110 based on the outer edge of the hub 201.

In addition, a circumferential direction refers to a rotation direction of the shaft 110, that is, a direction corresponding to an outer peripheral surface of the shaft 110.

The bearing assembly 100 may include a sleeve 120 supporting the shaft 110, a stopper 130 preventing excessive floating of the shaft 110, a base cover 140, and a flow prevention part 135.

The sleeve 120 may support the shaft 110 such that an upper end of the shaft 110 protrudes upwardly in an axial direction, and may be formed by processing or powder-sintering a metallic material such as a copper (Cu) or an SUS-based alloy, or the like.

Here, the shaft 110 is inserted into a shaft hole of the sleeve 120, having a micro clearance existing therebetween. The micro clearance is filled with oil O, and the rotation of the shaft 110 may be more stably supported by a fluid dynamic part 125 formed in at least one of an outer peripheral surface of the shaft 110 and an inner peripheral surface of the sleeve 120.

The fluid dynamic part 125 may generate radial dynamic pressure in the oil O and may be formed at each of upper and lower portions of the sleeve 120 in order to more effectively support the shaft 110 by the radial dynamic pressure.

However, the fluid dynamic part 125 may also be formed in the outer peripheral surface of the shaft 110 as well as in the inner peripheral surface of the sleeve 120 as described above. In addition, the number of the fluid dynamic parts is not limited.

Here, the fluid dynamic part 125 may be a groove having a herringbone shape, a spiral shape, or a screw shape. However, the fluid dynamic part 125 is not limited thereto but may have any shape as long as radial dynamic pressure may be generated by the rotation of the shaft 110.

The stopper 130 is a component coupled to the shaft 110 to thereby prevent excessive floating of a rotating member including the shaft 110. More specifically, the stopper 130 may be coupled to a lower portion of the shaft 110.

In this configuration, the stopper 130 may be separately manufactured and then coupled to the shaft 110, but may be formed integrally with the shaft 110 at the time of the manufacturing thereof and may rotate together with the shaft 110 at the time of the rotation thereof.

When the rotating member including the shaft 110 is excessively floated, an outer side portion of the stopper 130 contacts a bottom surface of the sleeve 120, whereby the excessive floating of the rotating member may be prevented.

Here, a thrust dynamic part (not shown) providing floating force of the rotating member may be formed in at least one of the stopper 130, the bottom surface of the sleeve 120 facing the stopper 130, and a top surface of a base cover 140 to be described below.

That is, in the motor 10 according to the embodiment of the present invention, when external power is applied to the coil 302 wound around the core 303, the shaft 110 and the hub 201 rotate. At this time, the shaft 110 and the stopper 130 may be floated and rotated by the oil O and thrust dynamic pressure generated by the thrust dynamic part (not shown).

The base cover 140 may maintain a clearance with the stopper 130 to thereby provide a space in which the oil O is filled and be coupled to the sleeve 120 to thereby seal a lower portion of the sleeve 120.

Here, the bearing assembly 100 according to the embodiment of the present invention may implement a full-fill structure in which only one side thereof is opened by the base cover 140. More specifically, the oil O provided to the bearing assembly 100 may be continuously filled in the clearance between the shaft 110 and the sleeve 120 and in the clearance between the base cover 140 and the stopper 130.

The flow prevention part 135 may protrude from the stopper 130 and prevent the flowing of the oil O filled between the stopper 130 and the base cover 140.

Here, a degree of flowing of the oil may determine a strength of damping force of the motor 10 according to the embodiment of the present invention. As the strength of the damping force becomes large, vibration characteristics for external impact, or the like, may be improved.

More specifically, when the external impact is applied to the motor 10 according to the embodiment of the present invention, the rotating member including the shaft 110, the stopper 130, and the hub 201 may be vibrated in an axial direction.

In this case, when the vibration of the rotating member in the axial direction is not damped and the stopper 130 thus contacts the base cover 140, there is a risk that the stopper 130 or the base cover 140 will be damaged. As a result, performance of the motor 10 according to the embodiment of the present invention is deteriorated.

However, in the case in which the rotating member is vibrated in the axial direction due to the external impact, or the like, when an appropriate amount of oil O, an incompressible fluid filled between the stopper 130 and the base cover 140, is maintained, the contact between the stopper 130 and the base cover 140 may be avoided to thereby prevent the performance of the motor 10 from being deteriorated.

Therefore, even in the case that the rotating member is vibrated in the axial direction due to the external impact, when a unit for maintaining the appropriate amount of oil O is provided, that is, even in the case that the external impact is applied, when a unit for preventing the flowing of the oil O is provided, the damping force for the external impact may be improved.

Here, the prevention of the flowing of the oil O filled between the stopper 130 and the base cover 140 indicates that a magnitude of pressure between the stopper 130 and the base cover 140 increases due to the incompressibility of the oil O.

That is, even in the case that the rotating member is vibrated in the axial direction due to the external impact, or the like, as the magnitude of the pressure acting between the stopper 130 and the base cover 140 increases, resistance to the downward movement of the stopper 130 in the axial direction increases, whereby contact between the stopper 130 and the base cover 140 may be prevented.

The bearing assembly 100 according to the embodiment of the present invention includes the flow prevention part 135 formed on a bottom surface of the stopper 130 and protruding downwardly in the axial direction in order to perform a series of operations as described above.

Here, the flow prevention part 135 may be continuously formed along the bottom surface of the stopper 130 in a circumferential direction and have the same outer diameter as that of the stopper 130.

Although FIGS. 1 and 2 show that the flow prevention part 135 is continuously formed along the bottom surface of the stopper 130, the present invention is not limited thereto. That is, the flow prevention part 135 may also be discontinuously formed along the bottom surface of the stopper 130.

In addition, the flow prevention part 135 may be formed symmetrically, based on the center of rotation of the stopper 130, and the flow prevention part 135, the stopper 130, and the shaft 110 may be formed integrally with each other.

Here, due to the flow prevention part 135, a clearance between the flow prevention part 135 and the base cover 140 may be smaller than the clearance between the stopper 130 and the base cover 140. As a result, the flow prevention part 135 may serve as an outer wall suppressing the flowing of the oil.

In addition, an inner space formed by the flow prevention part 135 may have a constant depth.

Additionally, the flow prevention part 135 is not limited to being formed on the bottom surface of the stopper 130 but may also be formed on a top surface of the base cover 140 and be formed on both of the bottom surface of the stopper 130 and the top surface of the base cover 140.

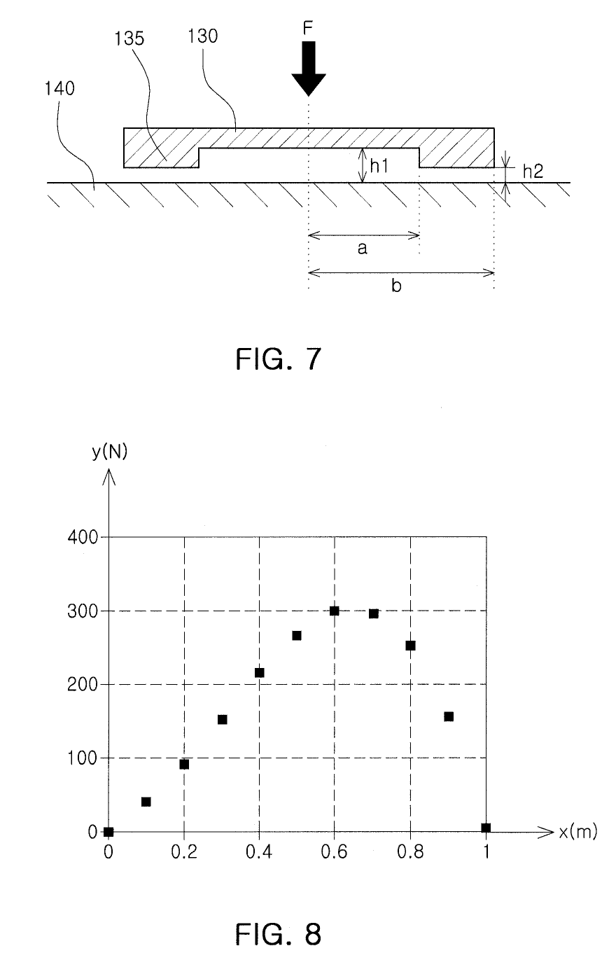

In addition, when the flow prevention part 135 has an inner diameter 0.6 times smaller than an outer diameter of the stopper 130 in an outer diameter direction, the damping force for the external impact, or the like, may be relatively maximized. A detailed description thereof will be provided below with reference to FIGS. 7 and 8.

The hub 201 may be a rotating structure rotatably provided with respect to a fixed member including the base 301.

In addition, the hub 201 may include an annular ring shaped magnet 202 provided on an inner peripheral surface thereof, wherein the annular ring shaped magnet 202 corresponds to the core 303, having a predetermined interval therebetween.

Here, the magnet 202 interacts with the coil 302 wound around the core 303, whereby the motor 10 according to the embodiment of the present invention may obtain rotational driving force.

The base 301 may be the fixed member supporting the rotation of the rotating member including the shaft 110 and the hub 201.

Here, the base 301 may include the core 303 coupled thereto, wherein the core 303 has the coil 302 wound therearound. The core 302 may be fixedly disposed on an upper portion of the base 301 including a printed circuit board (not shown) having circuit patterns printed thereon.

In other words, an outer peripheral surface of the sleeve 120 and the core 303 having the coil 302 wound therearound are inserted into the base 301, such that the sleeve 120 and the core 303 may be coupled thereto.

Here, as a method of coupling the sleeve 120 and the core 303 to the base 301, a bonding method, a welding method, a press-fitting method, or the like, may be used. However, a method of coupling the sleeve 120 and the core 302 to the base 301 is not necessarily limited thereto.

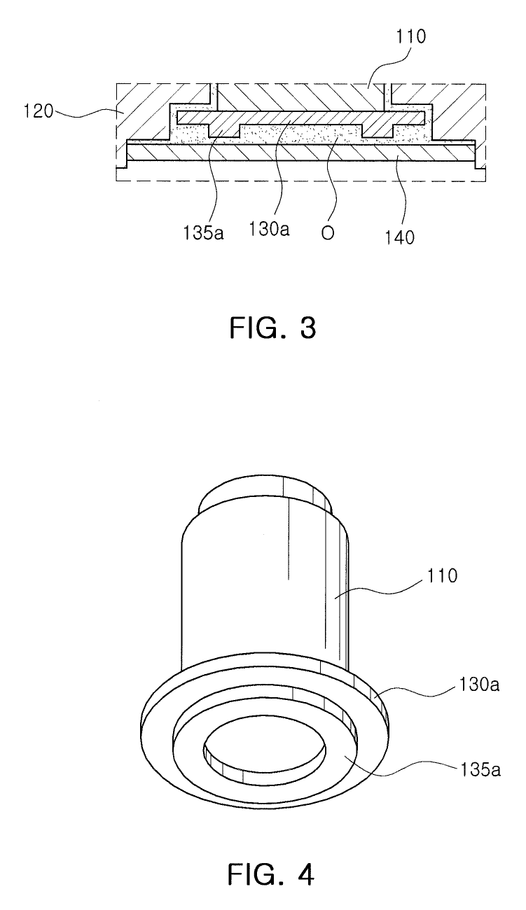

FIG. 3 is an enlarged cross-sectional view schematically showing a modified example of part A of FIG. 1, and FIG. 4 is a bottom perspective view schematically showing a shaft and a stopper provided in a modified example of part A of FIG. 1.

Referring to FIGS. 3 and 4, a stopper 130a and a flow prevention part 135a may have different outer diameters.

That is, the flow prevention part 135a may have a protrusion structure in which it protrudes along a bottom surface of the stopper 130a in a circumferential direction, and may be formed on both of the bottom surface of the stopper 130a and a top surface of the base cover 140 or be formed only on the top surface of the base cover 140.

In addition, the flow prevention part 135a having the protrusion structure may also be discontinuously formed.

Further, the protrusion structure is not limited to having a rectangular cross section but may also have cross sectional shapes variously altered according to a designer's intention.

Here, the flow prevention part 135a may serve as an outer wall capable of preventing the flowing of the oil O filled in an inner space formed by the flow prevention part 135a. Therefore, when an external impact, or the like, is applied, pressure generated in the inner space increases, whereby damping force for an external impact, or the like, may be improved.

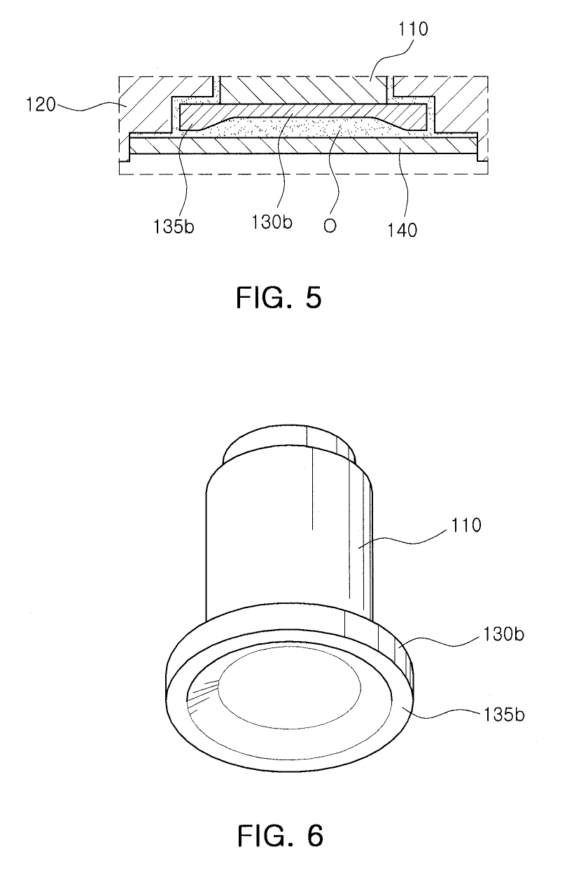

FIG. 5 is an enlarged cross-sectional view schematically showing another modified example of part A of FIG. 1, and FIG. 6 is a bottom perspective view schematically showing a shaft and a stopper provided in another modified example of part A of FIG. 1.

Referring to FIGS. 5 and 6, an inner space formed by a flow prevention part 135b may have different depths.

Even in this case, the flow prevention part 135b formed at the stopper 130b may prevent the flowing of the oil O filled in the inner space. Therefore, when the external impact, or the like, is applied, pressure generated in the inner space increases, whereby damping force for an external impact, or the like, may be improved.

FIG. 7 is an exploded cross-sectional view schematically showing a situation in which an external impact is applied to a stopper included in a bearing assembly according to an embodiment of the present invention, and FIG. 8 is a graph showing a relationship between an inner diameter of a flow prevention part included in a bearing assembly according to an embodiment of the present invention and damping force.

Referring to FIGS. 7 and 8, when an external impact F, or the like, is applied to the motor 10 according to the embodiment of the present invention, the rotating member including the shaft 110 and the stopper 130 is vibrated downwardly in an axial direction.

In this case, when a magnitude of damping force for the external impact F, or the like, may be calculated while a ratio of a radius a of an inner diameter of the inner space formed by the flow prevention part 135 to a radius b of an outer diameter of the stopper 130 is changed, results as depicted in the graph of FIG. 8 may be obtained.

Here, the magnitude of the damping force may be obtained by integrating pressure acting on the bottom surface of the stopper 130 when the external impact F, or the like, is applied, using an area by the radius a of the inner diameter of the inner space formed by the flow prevention part 135.

More specifically, when the magnitude of the damping force is calculated while the radius a of the inner diameter of the inner space formed by the flow prevention part 135 is changed on the assumption that a clearance h1 between the bottom surface of the stopper 130 and the base cover 140 is 1 mm, a clearance h2 between the flow prevention part 135 and the base cover 140 is 0.5 mm, a movement speed (v) of the stopper 130 in an axial direction due to the external impact F, or the like, is 0.1 mm/s, viscosity μ of the oil filled between the stopper 130 and the base cover 140 is 0.01 Pas, and the radius b of the outer diameter of the stopper 130 is 1 m; a result the same as that shown in the graph of FIG. 8 may be obtained.

An x axis of the graph of FIG. 8 indicates the radius a of the inner diameter of the inner space formed by the flow prevention part 135 in the case in which the radius b of the outer diameter of the stopper 130 is 1 mm, and a y axis thereof indicates the magnitude of the damping force obtained by integrating the pressure acting on the bottom surface of the stopper 130, using the area by the radius a of the inner diameter of the inner space formed by the flow prevention part 135.

Referring to the graph of FIG. 8, when the radius a of the inner diameter of the inner space formed by the flow prevention part 135 is 0 or 1, that is, when there is no flow prevention part 135, the damping force for the external impact F becomes close to 0.

However, there is damping force from the moment that the flow prevention part 135 is formed at the stopper 130, and the magnitude of the damping force gradually increases when the radius a of the inner diameter of the inner space formed by the flow prevention part 135 becomes 0.6 m.

It may be appreciated that after the radius a of the inner diameter of the inner space formed by the flow prevention part 135 exceeds 0.6 m, the magnitude of the damping force gradually decreases.

Therefore, when the radius a of the inner diameter of the inner space formed by the flow prevention part 135 is 0.6 m, the magnitude of the damping force for the external impact F may be relatively maximized.

In other words, when the inner diameter of the flow prevention part 135 is 0.6 times smaller than of the outer diameter of the stopper 130, the magnitude of the damping force for the external impact F may be relatively maximized.

As set forth above, with the bearing assembly and the motor including the same according to the embodiments of the present invention, even in the case that an external impact F, or the like, is applied, the flowing of the oil O is suppressed by the flow prevention part 135, 135a, or 135b, whereby displacement of the rotating member, including the shaft 110 in the axial direction, may be significantly reduced.

In addition, the displacement of the rotating member in the axial direction is significantly reduced to prevent contact between the rotating member and the fixed member, whereby performance and a lifespan of the motor may be improved.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft;
a stopper coupled to the shaft to thereby prevent excessive floating of the shaft;
a base cover maintaining a clearance with the stopper to thereby provide a space in which oil is filled and coupled to the sleeve; and
a flow prevention part protruding from at least one of the stopper and the base cover to thereby prevent a flowing of the oil.

2. The bearing assembly of claim 1, wherein the flow prevention part is continuously or discontinuously formed along a bottom surface of the stopper in a circumferential direction.

3. The bearing assembly of claim 1, wherein the flow prevention part has the same outer diameter as that of the stopper.

4. The bearing assembly of claim 1, wherein an inner space formed by the flow prevention part has a constant or differing depth.

5. The bearing assembly of claim 1, wherein the flow prevention part is formed symmetrically, based on the center of rotation of the stopper.

6. The bearing assembly of claim 1, wherein the flow prevention part has an inner diameter 0.6 times smaller than an outer diameter of the stopper.

7. The bearing assembly of claim 1, wherein the stopper and the shaft are formed integrally with each other.

8. A motor comprising:
the bearing assembly of claim 1;
a hub rotating together with the shaft and including a magnet coupled thereto; and
a base coupled to the sleeve and including a core having a coil wound therearound, the coil generating rotational driving force.
